(19) United States
(12) Patent Application Publication
(10) Pub. No.: US 2012/0017456 A1
(43) Pub. Date: Jan. 26, 2012

(54) CONDENSATION DRYER HAVING A FILTER DEVICE

(75) Inventor: Klaus Grunert, Berlin Reinickendorf (DE)

(73) Assignee: BSH BOSCH UND SIEMENS HAUSGERAETE GMBH, Munich (DE)

(21) Appl. No.: 13/262,276

(22) PCT Filed: Mar. 25, 2010
(86) PCT No.: PCT/EP10/53882

§ 371 Date: Sep. 30, 2011

(30) Foreign Application Priority Data
Apr. 15, 2009 (DE) 10 2009 002 389.5

(51) Int. Cl. F26B 21/06

(52) U.S. Cl. 34/82; 34/85

(57) ABSTRACT

A condensation dryer has a drying chamber for items to be dried, and a process air channel in which a heater for heating the process air and a fan for delivering the process air are located. A rinsing device is provided for rinsing lint from a component that can be loaded with lint, by means of condensate from a condensate collection vessel. Rinsed lint is collected by a filter bag of a filter device, and a condensate pump delivers the condensate into the condensate collection vessel, with the filter device and the being arranged downstream of the component. The filter bag includes a nonwoven fabric.

The invention relates to a condensation dyer having a drying chamber for items to be dried, a process air channel, in which a heater for heating the process air and a fan for conveying the process air are located, a component that can be loaded with lint, a condensate pan, a condensate collection vessel, a rinsing device for rinsing lint off the component using condensate from the condensate collection vessel, with a first filter device having a filter bag for collecting the rinsed off lint and a condensate pump for conveying the condensate into the condensate collection vessel connected downstream of the component.

In a condensation dryer air (known as process air) is directed by a fan by way of a heater into a drying chamber in the form of a drum containing damp laundry items. The hot air absorbs moisture from the laundry items to be dried. After passing through the drum the then moist process air is directed into a heat exchanger, upstream of which a lint filter is generally connected. Since the level of soiling of the lint filter increases over time, it is necessary to clean the lint filter from time to time.

A dryer for drying laundry using an air stream is known from EP 1 788 140 A1 and EP 1 788 141 A2 respectively. In the dryer a filter system for filtering lint out of an air stream is disposed in the process air guide in the region of a bearing shield, said filter system forming a first lint filter. A doctor blade scrapes the lint that has collected on the filter system in the process air guide off the filter fabric of the lint filter system and stores it in a container disposed adjacent to the doctor blade and to the filter system. However the dimensions of the container are relatively small due to the space available in the region of the doctor blade. Lint from around seven to ten drying processes can be collected therein. Since the lint is stored in the dry state, it takes up a relatively large amount of space. With such dryers on the one hand access to the collector is restricted and on the other hand the collection space is limited by its arrangement in a zone of the dryer with limited space, with the result that lint has to be removed from the container at relatively frequent intervals. The dryer also has a heater as the heat source and an air-air heat exchanger as the heat sink in the process air guide.

Condensation dryers are also known, in which a filter bag is present to collect lint. It is known for example to clean off or rinse lint present thereon from heat exchangers used in the condensation dryer with the aid of condensate and transport it to a filter bag. Such a filter bag must therefore receive not only lint but also condensate at least for a short time. The presence of condensate reduces the lint capacity in the filter bag. Also lint and condensate cannot be present in the filter bag in such a quantity that the filter bag is completely full and the condensate containing lint overflows.

The object of the present invention is therefore to provide a dryer of the type defined in the introduction, wherein the collection and disposal of lint is more efficient than with the prior art.

According to the present invention this object is achieved by a condensation dryer as claimed in the independent claim. Preferred embodiments of the invention are set out in the dependent claims and the description which follows.

The subject matter of the invention is therefore a condensation dryer having a drying chamber for items to be dried, a process air channel, in which a heater for heating the process air and a fan for conveying the process air are located, a component that can be loaded with lint, a condensate pan, a condensate collection vessel, a rinsing device for rinsing lint off the component using condensate from the condensate collection vessel, with a first filter device having a filter bag for collecting the rinsed off lint and a condensate pump for conveying the condensate into the condensate collection vessel connected downstream of the component. The filter bag here comprises a nonwoven fabric.

A nonwoven fabric within the meaning of the invention is generally defined according to DIN EN 29092 (ISO 9092). A nonwoven fabric is in particular a textile surface structure of individual fibers, in which in contrast to a fleece the fibers are at least partially connected.

Suitable nonwoven fabrics are in particular spunbond and needle-punch nonwoven fabrics. Spunbond nonwoven fabrics are generally produced by heating a polymer such as a polyester or polypropylene in an extruder and subjecting it to high pressure. The polymer is then pressed through a spin nozzle or nozzle plate. The filaments thus obtained are then isolated appropriately. The resulting tangled-layer fleece is then solidified appropriately by melting the fibers at certain contact points by applying concentrated heat. In some instances a polymer with a low melting point can also be added for solidification purposes, acting as a melting adhesive when heat is applied. In the case of the needle-punch nonwoven fabrics the fleece is in contrast generally solidified using various types of needle, e.g. crown needles. Also water jets have been frequently used in recent times to produce needle-punch nonwoven fabrics.

The nonwoven fabric used in the inventive condensation dryer is preferably a spunbond nonwoven fabric.

The nonwoven fabric used preferably comprises polyester and/or polypropylene. It is preferable for the nonwoven fabric and in particular the spunbond nonwoven fabric to be made of polyester. The polyester is preferably polyethylene terephthalate or polybutylene terephthalate.

The nonwoven fabric can have one or several layers, it being possible for the individual layers to be made of the same or a different material in the case of the embodiment with more than one layer.

The nonwoven fabric also preferably has a basis weight of 20 g/m² to 180 g/m² and particularly preferably 40 g/m² to 80 g/m². The inventively used nonwoven fabrics also generally have an air permeability at 100 Pa, measured according to DIN ISO 9237, in the region of 1500 l/m²sec to 5000 l/m²sec.

The nonwoven fabric is generally used with a thickness in the region of 0.1 mm to 0.5 mm for the filter bag of the inventive condensation dryer.

In the first filter device the use of the filter bag made of a nonwoven fabric means that particles up to a size of for example 40 μm can generally separated out, with a high level of water permeability being present at the same time. The particle retention capacity is a function of the material used and in particular its basis weight. The condensate or generally an aqueous fluid can generally flow out of a filled filter bag within 0.1 to 1 second. This high condensate outflow speed means that essentially only water bound due to the dampness of the lint is present in the filter bag, thereby significantly increasing the holding capacity of the inventively used filter bag. The period of use of a filter bag increases considerably as a result. For a user this means generally that the time interval after which the user has to replace or clean the filter bag is significantly extended.

Examples of nonwoven fabrics that are particularly suitable in respect of the invention are the polyester nonwoven fabrics known as Viledon® cooltex 7230, 7250, 7270 and H7210 produced by the Freudenberg company.

The first filter device with the filter bag made of nonwoven fabric can be used in a different manner in the inventive condensation dryer.

In one preferred embodiment the rinsing device comprising a rinse line, which projects into the process air channel between the drying chamber and a heat exchanger. This allows condensate to be used to clean different parts of the condensation dryer, it being possible for the condensate, then soiled for example by lint, to be filtered using the first filter device having the filter bag made of nonwoven fabric.

In a further preferred embodiment the component that can be loaded with lint is a second filter device, which is provided to trap lint from the process air in the process air channel and is disposed between the condensate collection vessel and the first filter device. The second filter device can thus be cleaned by rinsing off with an aqueous fluid, e.g. condensate, obtained during condensation of the moisture contained in the moist process air after it has passed through the drying chamber. The then soiled aqueous fluid or soiled condensate can then be filtered using the first filter device having the filter bag made of nonwoven fabric.

In a likewise preferred embodiment the component that can be loaded with lint is a heat exchanger for cooling the process air in the process air channel. The heat exchanger can thus also be cleaned by rinsing off with an aqueous fluid, e.g. condensate. The then soiled aqueous fluid or soiled condensate can then be filtered using the first filter device having the filter bag made of nonwoven fabric.

In the condensation dryer the first filter device is preferably accessible by way of an opening flap. The user of the condensation dryer can then remove the filter bag in a particularly simple manner to clean it or dispose of it.

In this context the inventive condensation dryer has a number of advantageous possibilities for eliminating the lint that is produced, since it is possible to clean the inventively used filter bag in a simple manner as well as disposing of it. It is proven surprisingly that just slight drying of the damp filter bag made of nonwoven fabric removed from the first filter device allows the filter cake to be detached easily as a compact mass and disposed of. If the filter bag is already dry, even this procedure is superfluous and the filter cake can be removed easily as a compact mass.

So that a user is optimally informed that cleaning is becoming necessary or it is necessary to change the filter bag being used, the inventive condensation dryer preferably comprises means for identifying and indicating a fill level of the filter bag. Thus for example a suitable sensor could determine the weight of the filter bag and, when a predefined upper threshold value for the weight of the filter bag is reached or exceeded, indicate that it is necessary to clean or dispose of the filter bag on an optical display device of the condensation dryer.

In one particularly preferred embodiment of the invention the condensation dryer is fitted with a heat pump.

In the case of a condensation dryer fitted with a type of heat pump known per se the cooling of the warm, moisture-laden process air essentially takes place in the evaporator of the heat pump, where the transferred heat is used to evaporate a coolant used in the heat pump. Such coolant, evaporated due to heating, is fed by way of a compressor to a second heat exchanger, in the following also referred to as the “condenser”, where heat is released due to the condensing of the gaseous coolant, said heat being used in turn to heat the process air before it enters the drum. The condensed coolant passes through a throttle valve, which reduces its pressure, back to the evaporator to evaporate there as it absorbs heat from the process air again. The evaporator therefore serves as a heat sink, in which heat is extracted from the process air flowing through. The condenser serves as a heat source, since heat from the heat pump is supplied to the process air therein. This heat has been pumped primarily by the heat pump from the heat sink to the heat source. Other types of heat pump are also known, in which heat is pumped from the heat sink to the heat source in a different manner, for example utilizing the Peltier effect or by means of a regenerative gas process.

The removal of lint is of particular importance in a condensation dryer fitted with a heat pump. Because of their structure heat pumps are generally integrated in the condensation dryer in such a manner that they cannot be removed from the condensation dryer to clean off lint. It is therefore even more important in the case of condensation dryers fitted with heat pumps to clean soiling, e.g. lint, off the heat pump, in particular off the evaporator of the heat pump, in an efficient manner.

A lint filter is generally present in a process air channel to eliminate lint. When a lint filter system is used, the lint remains suspended in a fine-meshed filter and is then removed mechanically by the user after drying. However not all the lint is held even when a lint filter system is used. Finer lint can pass through the lint filter system and be separated out at different points in the process air channel, thereby preventing the exchange of heat in a downstream heat exchanger for example.

The invention has the advantage that the elimination of lint in the condensation dryer can be performed more effectively. Lint produced in an inventive condensation dryer can not only be bound but also rinsed out by means of diverted condensate and can be separated in a simple manner from the condensate, which can then be supplied for further use. The improved exchange of heat in the heat exchanger due to more efficient cleaning allows the condensation dryer to be operated with a more favorable energy balance. It also means that less strain is placed on a heat pump present in the condensation dryer.

The advantageous separation of lint and condensate not only allows the condensate to be reused, it also allows longer intervals for the disposal of the accumulated lint by a user of the condensation dryer.

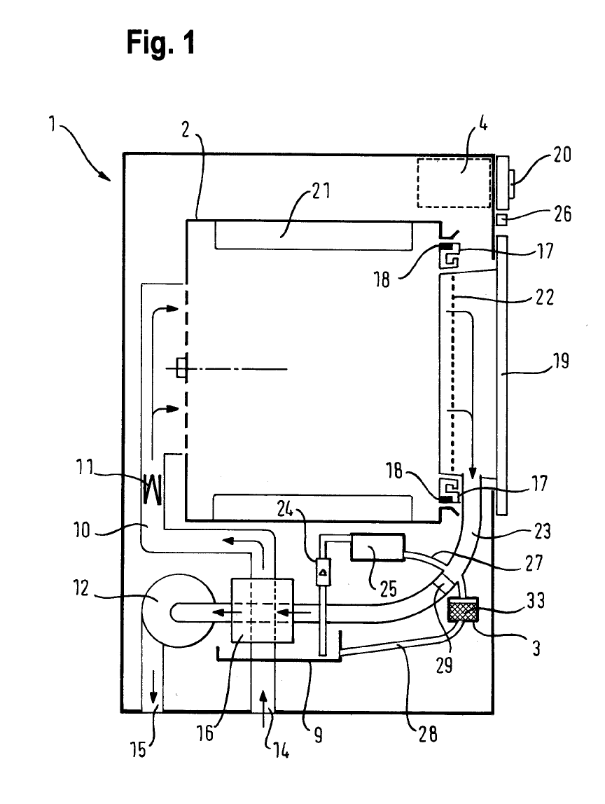

Further details of the invention will emerge from the description which follows of non-restrictive exemplary embodiments of the inventive condensation dryer and a method using said condensation dryer. Reference is made here to FIGS. 1 to 3, in which:

FIG. 1 shows a vertical section through a condensation dryer according to a first embodiment. The condensation dryer is embodied as an exhaust air dryer here.

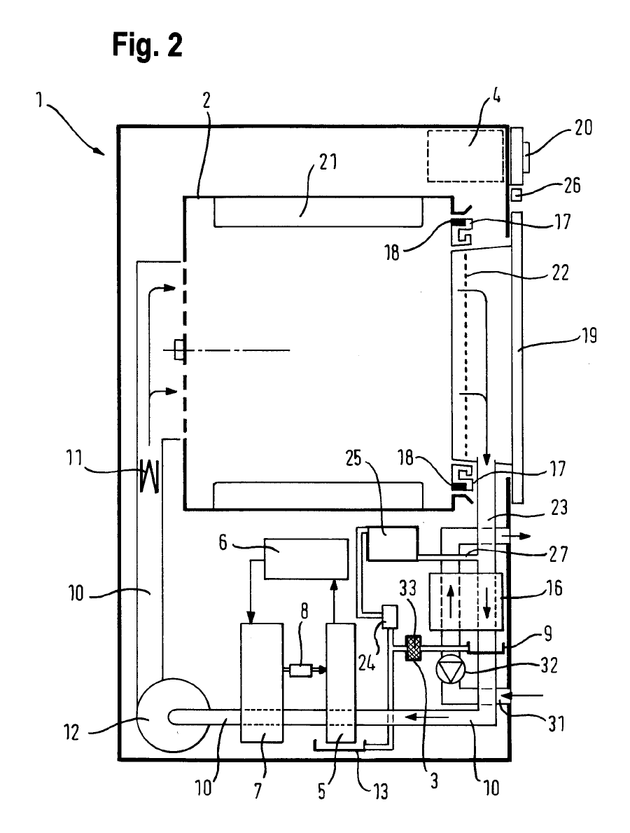

FIG. 2 shows a vertical section through a condensation dryer according to a second embodiment. The condensation dryer is embodied as a circulating air dryer here.

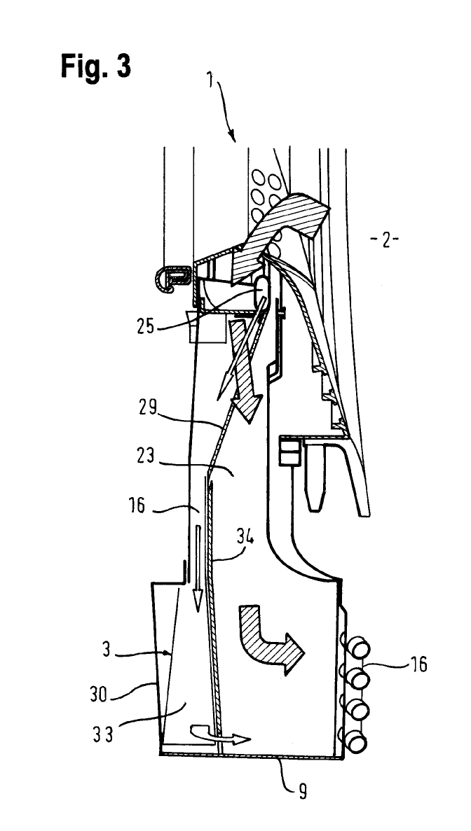

FIG. 3 shows a vertical section through the parts of a condensation dryer according to a third embodiment that are of significance for the present invention.

The exhaust air dryer 1 according to a first embodiment illustrated in FIG. 1 features a drying chamber in the form of a drum 2 that can be rotated about a horizontal axis, within which drum agitators 21 are fixed to move laundry during a drum rotation. Process air is conducted by means of a fan 12 by way of a heater 11 and through the drum 2 in a process air channel 10. External air is fed to the process air channel 10 by way of an air intake channel 14 or sucked in by the fan 12. After passing through the drum 2 the then moist, warm process air enters an exhaust air channel 23. Air heated by the heater 11 is in particular directed from the rear, i.e. from the side of the drum 2 opposite a door 19, through its perforated base into the drum 2, comes into contact there with the laundry to be dried and streams through the loading opening of the drum 2 to a lint filter system 22 within a door 19 closing off the loading opening. The process air stream in the door 19 is then deflected downward. The process air is fed in the exhaust air channel 23 to an air-air heat exchanger 16, in which the warm, moisture-laden process air is cooled and then conducted to an exhaust air outlet 15. The separated moisture is collected in a condensate pan 9, from whence it is conveyed by means of the condensate pump 24 into the condensate collection vessel 25.

External air supplied to the dryer 1 by way of the air intake channel 14 is used for cooling in the air-air heat exchanger. This intake air is heated by the warm, moisture-laden process air and then again by means of the heater 11 before entering the drum 2.

In the embodiment shown in FIG. 1 the drum 2 is supported at the rear of the base by means of a rotary bearing and at the front by means of a bearing shield 17, the drum 2 resting with a rim on a slide strip 18 on the bearing shield 17 and being held by this and by rollers (not visible in the figure), on which the rim can roll, at the front end. The exhaust air dryer 1 is controlled by way of a program controller 4, which can be regulated by the user by way of an operating unit 20.

A rinse line 27 passes from the condensate collection vessel 25 to the exhaust air channel 23 above a second filter device 29. Condensate conveyed by means of the condensate pump 24 into the condensate collection vessel 25 can thus be used to rinse the second filter device 29, i.e. to rinse off lint on the second filter device 29. The lint rinsed off by condensate reaches the first filter device 3, which contains a filter bag 33 made of a polyester nonwoven fabric known as Viledon® cooltex 7230, 7250 or 7270 produced by the Freudenberg company. The basis weight of the spunbond nonwoven fabrics used is 30, 50 and 70 g/m². The lint present in the condensate remains in the filter bag 33, while the condensate filtered in this manner flows by way of a discharge line 28 back into the condensate pan 9, from whence it can be conveyed again by means of the condensate pump 24 to the condensate collection vessel 24 where it is available for further cleaning steps.

26 designates a display means for showing information about the fill level of the filter bag 33 of the first filter device 3. The program controller 4 comprises means for identifying a fill level of the filter bag 33. This may be a clock (not shown), which totals up the duration of drying processes and is reset to zero when the filter is changed or cleaned, or an evaluation unit for an optionally provided weight sensor.

FIG. 2 shows a vertical section through a condensation dryer according to a second embodiment. In the embodiment shown in FIG. 2 a first condensate pan 9 and a second condensate pan 13 are connected to a condensate collection vessel 25 by way of a condensate pump 24.

A rinse line 27 passes from the condensate collection vessel 25 to the exhaust air channel 23 above the air-air heat exchanger 16. Condensate conveyed into the condensate collection vessel 25 by means of the condensate pump 24 can thus be used to rinse off lint adhering to the air-air heat exchanger 16. In the second embodiment shown here the lint rinsed off by condensate passes first to the first condensate pan 9 and then to a first filter device 3, which contains a filter bag 33 made of a polyester nonwoven fabric known as Viledon® cooltex 7230, 7250 or 7270 produced by the Freudenberg company. The basis weight of the spunbond nonwoven fabrics used is 30, 50 and 70 g/m². The lint present in the condensate remains in the filter bag 33, while the condensate filtered in this manner can either flow on into the second condensate pan 13 or can be conveyed by means of the condensate pump 24 back to the condensate collection vessel 25, where it is available for further cleaning steps.

The dryer 1 shown in FIG. 2 likewise features a drying chamber 2 in the form of a drum that can be rotated about a horizontal axis, within which agitators 21 are fixed to move laundry during a drum rotation. However in the embodiment shown in FIG. 2 process air is conducted by means of a fan 12 by way of a heater 11, through a drum 3, an air-air heat exchanger 16 and a heat pump 5, 6, 7, 8 in the closed circuit in a process air channel 10. After passing through the drum 2 the moist, warm process air is cooled and heated again after condensation of the moisture contained in the process air. Air heated by the heater 11 is hereby directed from the rear, i.e. from the side of the drum 3 opposite a door 19, through its perforated base into the drum 3, comes into contact there with the laundry to be dried and streams through the loading opening of the drum 3 to a lint filter system 22 within a door 19 that closes off the loading opening. The air stream in the door 19 is then deflected downward and directed from the process air channel 10 to the air-air heat exchanger 16. The moisture absorbed from the laundry by the process air condenses there as it cools and is collected in a first condensate pan 9. The somewhat cooled process air is then conducted to the evaporator 5 of the heat pump 5, 6, 7, 8, where it is cooled further. Below the evaporator 5 is a second condensate pan 13. The condensate produced in the first condensate pan 9 and/or the second condensate pan 13 is pumped into the condensate collection vessel 25 by means of a condensate pump 24.

The coolant of the heat pump 5, 6, 7, 8 evaporated in the evaporator 5 is conducted by way of a compressor 6 to the condenser 7. In the condenser 7 the coolant loses heat to the process air and condenses. The coolant, which is now present in fluid form, is conducted back to the evaporator 5 by way of a throttle valve 8, as a result of which the coolant circuit is closed. The cooling air is taken from the external air and after passing through the air-air heat exchanger 16 is fed back to the external air. A cooling air fan 32 is present in the cooling air channel 31 for this purpose.

FIG. 2 also represents a dryer 1, which in addition to the heat pump 5, 6, 7, 8 also does not have an air-air heat exchanger 16. In this dryer 1 therefore the evaporator 5 (or a different heat sink depending on the type of heat pump) is the only component at which heat is extracted from the process air. The heater 11 can also be dispensed with in such a dryer.

The drum 2 is supported at the rear of the base by means of a rotary bearing and at the front by means of a bearing shield 7, the drum 3 resting with a rim on a slide strip 8 and rollers (not visible) on the bearing shield 7, thus being held at the front end. The circulating air dryer is controlled by way of a control facility 4, which can be regulated by the user by way of an operating unit 20.

FIG. 3 shows a vertical section through the parts of a condensation dryer according to a third embodiment that are of relevance to the present invention.

It shows a section through a bearing shield of the dryer 1 present on the front face, with a drying chamber 2 in the form of a drum 2 (not shown in detail here) adjacent thereto. The flow direction of the process air is shown by large arrows. The process air exits top right out of the drying chamber 2 and streams through a second filter device 29 at an angle to it in a vertical downward direction in order, after being deflected in a horizontal direction, to reach the heat exchanger 16. Condensate flows as shown by the small arrows out of the condensate collection vessel 25 (only shown in outline) by way of the obliquely positioned second filter device 29, where it picks up lint that has been deposited there. The condensate then passes into a first filter device 3, which is fitted with a filter bag 33. The first filter device 3 has an opening flap 30 and a separating wall 34. In a lower region the separating wall 34 is permeable so that the filtered condensate can pass through to the condensate pan 9. Behind the flap 30 is a filter bag 33 made of polyester nonwoven fabric, which holds the lint rinsed off by means of the condensate in the embodiment shown here. When the filter bag 33 is full of lint, which can in some instances be monitored by a suitable monitoring facility and can be indicated for example on a display means (not shown in detail here), it can be removed by opening the flap 30. This allows the lint to be disposed of without having to be touched directly.

The invention provides a new way of disposing of the lint produced in a dryer for laundry or the like in such a manner that any impairment of each drying process is avoided as largely as possible, with the lint being rendered into a compact form that is particularly suitable for disposal. Such a dryer is therefore characterized by particular simplicity of use.

### LIST OF REFERENCE CHARACTERS

1 Dryer (exhaust air or circulating air dryer)
2 Drying chamber
3 First filter device
4 Program controller
5 Evaporator
6 Compressor
7 Condenser
8 Throttle valve
9 (First) Condensate pan
10 Process air channel
11 Heater
12 Fan
13 Second condensate pan
14 Air intake channel
15 Exhaust air outlet
16 Air-air heat exchanger
17 Bearing shield
18 Slide strip
19 Door
20 Operating unit
21 Agitator
22 Lint filter system
23 Exhaust air channel
24 Condensate pump
25 Condensate collection vessel
16 Display means
27 Rinse line
28 Discharge line
29 Second filter device
30 Flap
31 Cooling air channel
32 Cooling air fan
33 Filter bag
34 Separating wall

1-11. (canceled)

12. A condensation dryer, comprising:
a drying chamber for items to be dried;
a heater arranged in a process air channel for heating process air;
a fan arranged in the process air channel for conveying the process air;
a component that can be loaded with lint;
a condensate collection vessel;
a rinsing device for rinsing lint off the component using condensate from the condensate collection vessel;
a first filter device arranged downstream of the component and having a filter bag for collecting the rinsed off lint, said filter bag comprising a nonwoven fabric; and
a condensate pump arranged downstream of the component for conveying the condensate into the condensate collection vessel connected.

13. The condensation dryer of claim 12, further comprising a condensate pan for collecting moisture separated from the process air, said condensate pump conveying condensate from the condensate pan into the condensate collection vessel.

14. The condensation dryer of claim 12, wherein the nonwoven fabric is a spunbond nonwoven fabric.

15. The condensation dryer of claim 12, wherein the nonwoven fabric comprises at least one of polyester and polypropylene.

16. The condensation dryer of claim 12, wherein the nonwoven fabric is made of polyester.

17. The condensation dryer of claim 16, wherein the polyester is polyethylene terephthalate or polybutylene terephthalate.

18. The condensation dryer of claim 12, wherein the nonwoven fabric has a basis weight of 20 to 180 g/m².

19. The condensation dryer of claim 12, wherein the component is a heat exchanger, said rinsing device comprising a rinse line, which projects into the process air channel between the drying chamber and the heat exchanger.

20. The condensation dryer of claim 12, wherein the component is a second filter device, which is provided to trap lint from the process air in the process air channel and is disposed between the condensate collection vessel and the first filter device.

21. The condensation dryer of claim 12, wherein the component is a heat exchanger for cooling the process air in the process air channel.

22. The condensation dryer of claim 12, wherein the first filter device has an opening flap for access.

23. The condensation dryer of claim 12, wherein the condensation dryer is constructed for identifying and indicating a fill level of the filter bag.
